(19) United States
(12) Patent Application Publication
(10) Pub. No.: US 2014/0156379 A1
(43) Pub. Date: Jun. 5, 2014

(54) Method and Apparatus for Hierarchical-Model-Based Creative Quality Scores

(71) Applicant: ADOBE SYSTEMS INCORPORATED, San Jose, CA (US)

(72) Inventors: Abhishek Pani, San Francisco, CA (US); Davide Imperati, Gessate (IT); Zhenyu Yan, Sunnyvale, CA (US)

(73) Assignee: ADOBE SYSTEMS INCORPORATED, San Jose, CA (US)

(21) Appl. No.: 13/691,442

(22) Filed: Nov. 30, 2012

(51) Int. Cl. G06Q 30/02

(52) U.S. Cl. CPC G06Q 30/0242
USPC 705/14.41

(57) ABSTRACT

Performance data for online advertisement creatives may be received. A hierarchical model of the online advertisement creatives may be generated based on correlations among the online advertisement creatives. The hierarchical model may be used to estimate a respective performance value for each of at least some of the plurality of online advertisement creatives based on the received performance data. A creative quality score may be determined, for those online advertising creatives whose performance values were estimated, based on the estimated performance values.

### BACKGROUND

For online advertising (e.g., search engine marketing), when a keyword within an advertisement group matches a user-inputted keyword, the search engine selects a creative from creatives of the advertisement group to participate in an auction. The auction determines the position to show the creative. A creative is a combination of title, text body, image, and/or other dimensions that describes selectable (e.g., clickable) advertisements.

Clicks, conversions, or other relevant events are usually sparse for a single creative. Therefore, it is unreliable to estimate Click Through Rate (CTR), Revenue Per Click (RPC), and/or other metrics solely on data associated with the individual creative.

### BRIEF DESCRIPTION OF THE DRAWINGS

FIG. 1 is a block diagram that illustrates an example system that may implement hierarchical-model-based creative quality scoring, according to some embodiments.

FIG. 2 is a flowchart that illustrates a method for hierarchical-model-based creative quality scoring, according to some embodiments.

FIG. 3 is a block diagram that illustrates an example hierarchical model that is usable to estimate performance values for advertisement creatives, according to some embodiments.

FIG. 4 illustrates an example of an interface useable to display creative quality scores and/or continue or pause a creative, according to some embodiments.

FIG. 5 illustrates an example computer system that may be used in accordance with one or more embodiments.

### DETAILED DESCRIPTION OF EMBODIMENTS

The following specification describes leveraging the hierarchical structure of online advertisements to generate a robust advertiser-side creative quality score. A creative is used herein to describe a combination of title, text body, image, and/or other dimensions that describes selectable (e.g., clickable) advertisements. Data (e.g., clicks, conversions, revenue, etc.) for individual creatives is typically sparse such that little, if any, data exists for a given creative. By utilizing the hierarchical model to generate a creative quality score, data for similarly situated creatives may be leveraged and a more robust creative quality score may be generated.

In the following detailed description, numerous specific details are set forth to provide a thorough understanding of claimed subject matter. However, it will be understood by those skilled in the art that claimed subject matter may be practiced without these specific details. In other instances, methods, apparatuses or systems are not described in detail below because they are known by one of ordinary skill in the art in order not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

“First,” “Second,” etc. As used herein, these terms are used as labels for nouns that they precede, and do not imply any type of ordering (e.g., spatial, temporal, logical, etc.). For example, for a hierarchical model to estimate performance values used in a creative quality score, the terms “first” and “second” levels of the hierarchy can be used to refer to any two levels of the hierarchy. In other words, the “first” and “second” levels are not limited to logical levels 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Advertisement Creative.” As used herein, this term is used to describe a combination of title, text body, image, and/or other dimensions that describes selectable (e.g., clickable) online advertisements.

“Creative Quality Score.” As used herein, this term is used to describe a quantitative score for advertisement creatives. For example, the creative quality score may quantitatively measure the effectiveness (e.g., click through rate, conversion rate, etc.) of an advertisement creative.

“Hierarchical model.” As used herein, this term is used to describe a model of the hierarchy of the online advertisement creatives. For example, multiple online advertisement creatives may belong to an advertisement group. One or more advertisement groups may belong to an advertising campaign and one or more advertisement portfolios may belong to a user account. Data regarding various elements of the hierarchy may be shared so that data from the hierarchy may be leveraged to generate more robust creative quality scores for individual creatives.

Various embodiments of methods and apparatus for hierarchical-model-based creative quality scores are described. Some embodiments may include a means for determining a creative quality score. For example, a scoring module may receive performance data for a plurality of online advertisement creatives, generate a hierarchical model of the creatives, use the hierarchical model to estimate respective performance values for the creatives, and determine a creative quality score based on the performance values. The scoring module may, in some embodiments, be implemented by program instructions stored in a computer-readable storage medium and executable by one or more processors (e.g., one or more CPUs or GPUs) of a computing apparatus. The computer-readable storage medium may store program instructions executable by the one or more processors to cause the computing apparatus to perform receiving performance data for a plurality of online advertisement creatives, generating a hierarchical model of the creatives, using the hierarchical model to estimate respective performance values for the creatives, and determining a creative quality score based on the performance values, as described herein. Other embodiments may be at least partially implemented by hardware circuitry and/or firmware stored, for example, in a non-volatile memory.

Although certain embodiments are described with respect to a search engine, webpage, and/or website, it will be appreciated that the techniques disclosed herein may be employed with other forms of network content sites that may present online advertisements, such as documents with a traversable tree-like hierarchy (e.g., XML, HTML, etc.).

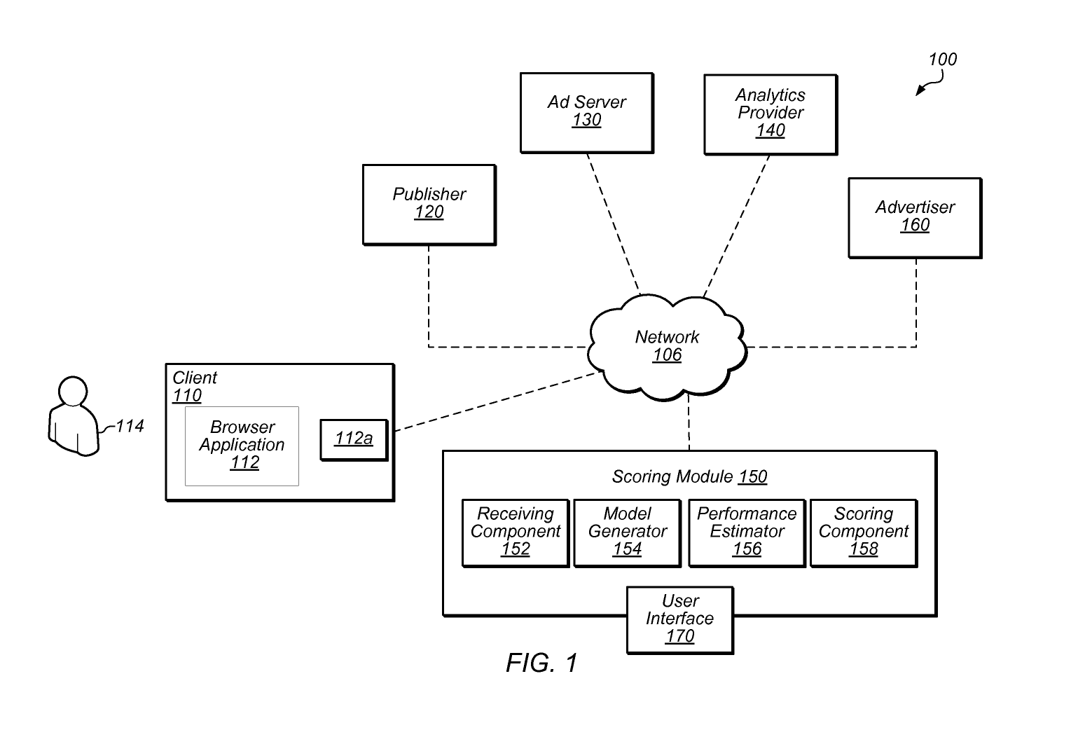

Turning now to the figures, FIG. 1 is a block diagram that illustrates a hierarchical-model-based creative quality scoring system 100, according to some embodiments of the present disclosure. In the illustrated embodiment, system 100 includes client 110, publisher 120, advertisement (ad) server 130, analytics provider 140, scoring module 150, receiving component 152, model generator 154, performance estimator 156, scoring component 158, and advertiser 160. Client 110, browser application 112, publisher 120, ad server 130, analytics provider 140, scoring module 150, receiving component 152, model generator 154, performance estimator 156, scoring component 158, and advertiser 160 may each include, employ or be executed on one or more computer systems.

Each component of system 100 may be communicatively coupled to one another via one or more network 108. Network 108 may include any channel for providing effective communication between each of the entities of system 100. In some embodiments, network 108 includes one or more electronic communication networks, such as the internet, a local area network (LAN), wireless LAN (WLAN), WiMAX network, cellular communications network, or the like. For example, network 108 may include an internet network used to facilitate communication between each of the entities (e.g., client 110, publisher 120, advertisement (ad) server 130, analytics provider 140, scoring module 150, and advertiser 160) of system 100.

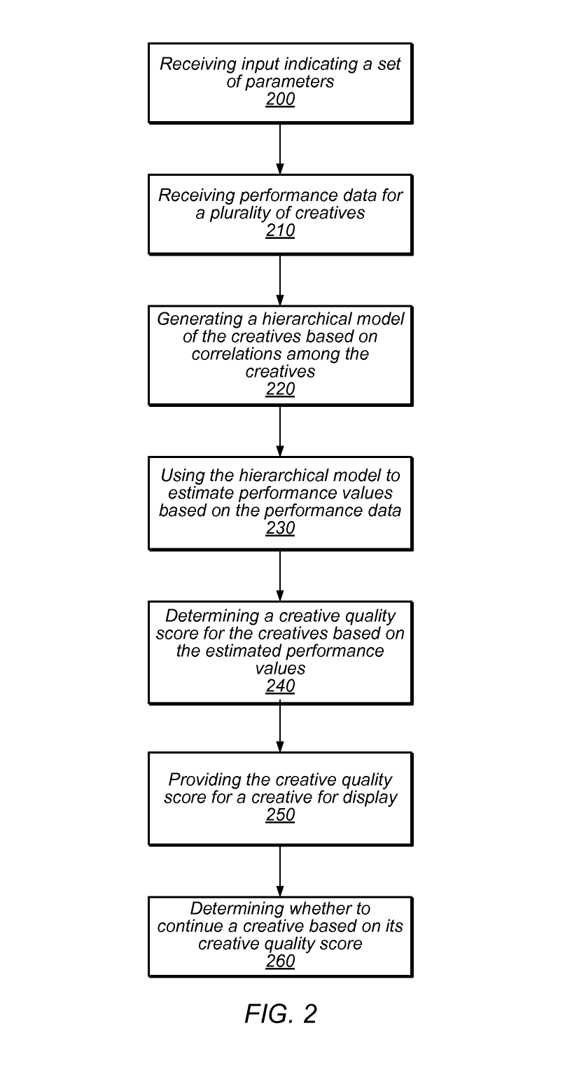

Scoring module 150 may implement the disclosed hierarchical-model-based creative quality scoring techniques, as described herein (e.g., the method of FIG. 2). In one embodiment, scoring module 150 may leverage the hierarchical structure of online advertisements to generate a robust advertiser-side creative quality score. Receiving component 152 of scoring module 150 may receive, from analytics provider 140 for example, performance data for a plurality of online advertisement creatives. Examples of performance data include data regarding revenue, conversions, impressions, and/or clicks, among others.

In one embodiment, model generator 154 of scoring module 150 may then generate a hierarchical model of the online advertisement creatives based on correlations among the online advertisement creatives. The hierarchical model may be used by performance estimator 156 to estimate a respective performance value for each of at least some of the plurality of online advertisement creatives based on the received performance data.

In various embodiments, a creative quality score may be determined by scoring component 158, for those online advertising creatives whose performance values were estimated, based on the estimated performance values. The creative quality score may be used to determine whether to continue or pause various creatives. For example, scoring component 158 or some other component of scoring module 150 may make such a determination. In response to determining whether to continue or pause a creative, scoring module 150 may provider an indication of such a determination to one or more of advertiser 160, ad server 130, and/or publisher 120 to effectuate the determination (e.g., remove a creative from or add a creative to a list of available active creatives). Note that in various embodiments, scoring module 150 may reside in analytics provider 140, advertiser 160, or elsewhere. User interface 170 may permit a user to interact (e.g., via pointing device, touch, voice, etc.) with scoring module to select whether to continue or pause a creative, and/or to input one or more parameters (e.g., advertising parameters, creative selection preferences scoring parameters, automatic or manual mode, etc.). Additional details of embodiments of scoring module 150 are described at FIGS. 2-4.

In one embodiment, advertiser 160 may design the creatives. The creatives and creative selection preferences and/or advertising parameters may be provided to scoring module 150, ad server 130, and/or publisher 120. Advertising parameters may include: a selection of publisher, which creatives are in an ad group, ad placement, target audiences, and campaign budgets. Selection preferences may include a maximum number of active creatives, the duration for which to make a creative active or inactive, and/or the mode of ad serving. For example, ad serving modes may include an optimize mode or a rotate mode. In rotate mode, the publisher may select multiple creatives within an ad group to enter an ad auction with approximately equal number of times. In optimize mode, the publisher may decide which creative to choose and enter the ad auction based on an algorithm at the publisher. Additionally, in an embodiment in which scoring module 150 provides an indication of the determination of whether to continue a creative to advertiser 160, advertiser 160 may include the determination in its selection preferences. For example, based on the determination, advertiser 160 may remove an inactive creative from an ad group or add an active creative to an ad group.

Ad server 130 may store the various creatives and provide the selected creative to publisher 120 for providing to a browser of client 110. In some embodiments ad server 130 may receive, from scoring module 150, the indication of whether to continue or pause a creative, as described herein. Thus, if a creative is continued (e.g., kept active), then it is eligible for selection from ad server 130. If the creative paused and made inactive, then it is no longer eligible for selection until the creative is reinstated. In some embodiments, selection of a creative may be performed by a component other than ad server 130, such as publisher 120 (e.g., a search engine). In such embodiments, ad server 130 may simply receive an indication of which creative is selected and then provide the selected creative to publisher 120. In other embodiments, ad server 130 may include logic that takes a variety of inputs (e.g., active/inactive status from scoring module 150, selection preferences and advertising parameters from advertiser 160, and/or other inputs, etc.) and determines which creative to select and provide to publisher 120 based on those inputs.

Publisher 120 may be the source of network content that is provided to client 110. For example, publisher 120 may include media portals or websites used to present media. Such media portals or websites may include search engines, webmail sites, social networking sites, other websites, etc. In some embodiments, publisher 120 may include a content server, which may provide network content (e.g., web pages) to client 110. In one embodiment, publisher 120 may select an active creative from an advertisement group (ad group) of creatives to publish to client 110. For example, publisher 120 may receive selection preferences and/or advertising parameters from advertiser 160 and/or an indication of whether to continue/pause various creatives from scoring module 150, which may dictate which creative is selected. Publisher 120 may retrieve the creative from ad server 130 to publish the creative, along with other content, to client 110.

Client 110 may include a computer, mobile device (e.g., cellular phone, tablet device, etc.), or similar device used to access content provided by publisher 120. In some embodiments, client 110 may include a computer employing a browser application 112 that is used to interact with webpages and websites provided by publisher 120. For example, browser application 112 may render a webpage of publisher 120. Rendering may include executing HTML code for the webpage provided by publisher 120. As a result, browser may also generate appropriate request for data from various servers of system 100 to assemble the webpage and one or more online advertisement creatives for display on client 110. The webpage and/or creative(s) may be viewed by a user via a monitor or similar presentation device at client 110.

Analytics provider 140 may include a system for the collection and processing of data indicative of content interactions by a user (e.g., browsing activity, cookies, conversions, revenue, network analytics, web analytics, etc.), such as interactions with a creative, to determine performance data for the online advertisement creatives. As mentioned above, performance data may include data regarding revenue, conversions, impressions, and/or clicks, among others. Note that analytics provider 140 may include a third-party website traffic statistic service that is a physically separate entity from publisher 120. Additionally, in some embodiments, analytics provider 140 may reside on a different network location from publisher 120 and client 110.

Analytics provider 140 may collect data via various techniques. For example, upon loading/rendering of a webpage 112a by browser 112 of client 110, browser 112 may generate a request to analytics provider 140 via network 108. Analytics provider 140 may process the request by returning appropriate content to browser 112 of client 110. Analytics provider 140 may record the request, for example in a data store, and record additional information associated with the request (e.g., the date and time and/or identifying information that may be encoded in the resource request).

Analytics provider 140 may parse the data indicative of content interactions and extract the performance data. Performance data may be stored in a data store of analytics provider 140 or in a data store remote from analytics provider 140. In one embodiment, analytics provider 140 may provide the performance data regarding the online advertising creatives to scoring module 150.

In some embodiments, a user 114 interacts with a device at client 110, to execute a software application, such as browser application 112 of client 110, for accessing and displaying one or more webpages 112a. In response to a user command, such as clicking on a link or typing in a uniform resource locator (URL), browser application 112 may issue a webpage request to a web content server of publisher 120 via network 108 (e.g., via the Internet). In response to such a request, the content server may transmit the corresponding webpage code (e.g., HTML code corresponding to webpage 112a) and one or more online advertising creatives to browser application 112. Browser application 112 may interpret the received webpage code and creative to display the requested webpage and creative to user 114 at client 110. Browser application 112 may generate additional requests for content from the server, as needed.

In some embodiments, client 110 also transmits webpage visitation tracking information to analytics provider 140. For example, webpage code 124 may include executable code to initiate a request for data from analytics provider 140 such that execution of the webpage code causes browser 112 to generate a corresponding request for the data to analytics provider 140. In some embodiments, the request itself may have analytics data contained therein or associated therewith, such that transmitting request causes transmission of analytics data from client 110 to analytics provider 140. Analytics provider 140 may process (e.g., parse) the request to extract data indicative of content interactions (e.g., analytics data) contained in or associated with the request. In some embodiments, analytics provider 140 may transmit data indicative of content interactions and/or a corresponding report to scoring module 150, or other interested parties. Scoring module 150 may then perform the disclosed hierarchical-model-based creating scoring techniques on such data.

Turning now to FIG. 2, one embodiment of hierarchical-model-based creative quality scoring is illustrated. While the blocks are shown in a particular order for ease of understanding, other orders may be used. In some embodiments, the method of FIG. 2 may include additional (or fewer) blocks than shown. Blocks 200-260 may be performed automatically or may receive user input. In one embodiment, the method of FIG. 2 may be performed by scoring module 150.

At 200, in one embodiment, input indicating a set of parameters may be received, for example, by receiving component 152 of scoring module 150. The set of parameters may be user configurable and may be received via a user interface, such as user interface 170. In such an embodiment, determining the creative quality scores, as described at block 240, may be based at least in part on the set of parameters. The parameters may include advertisement parameters and/or scoring parameters. Example scoring parameters may include a selection of using the mean scores or confidence intervals or both to determine whether to continue a creative. Example advertisement parameters may include defining the hierarchy of the creatives by indicating which creatives belong to which advertisement group, and which advertisement groups belong to which ad campaign, etc. Other example advertisement parameters include a parameter that indicates whether pausing/continuing of a creative is performed automatically or needs user input to effectuate a change in the creative status.

As illustrated at 210, performance data for a plurality of online advertising creatives may be received, for example, by receiving component 152 of scoring module 150. Performance data may include data regarding revenue, conversions, impressions, and/or clicks, among others. In one embodiment, performance data may be received for each of the online advertising creatives that have data associated with them. For example, if creatives 1-5 have data for them but creatives 6-9 do not, then performance data may be received for creatives 1-5 but not for creatives 6-9. Performance data, which may also be referred to as analytics data, may be generated in a variety of ways. For example, such data may be generated in response to selection of a selectable element (e.g., a link, button, anything with an onclick attribute, bookmark, etc.) from the content (e.g., network content, website, FTP site, etc.), in response to a conversion, or in response to a creative impression.

In one embodiment, the performance data may be received from an analytics provider. The performance data may be generated upon execution of code within network content (e.g., a website). In one embodiment, in addition to or instead of receiving performance data from the analytics provider, performance data may be received directly from an advertiser who owns and/or manages the plurality of online advertising creatives and/or from a third party data aggregator that stores data (e.g., cookies) regarding performance of the creatives.

In various embodiments, the received performance data for the creatives may be sparse for at least one of the creatives. For instance, in the simple example above, creatives 6-9 did not have any performance data associated with those creatives. Consider another simple example for one of the creatives that does have performance data associated with it. The creative may only be clicked 1% of its impressions and a conversion may take place and/or revenue generated only 1% of the time a click occurs (e.g., 1% of 1%). Thus, in such an example, conversion and/or revenue generation may only take place 0.01% of the impressions of the creative. The 0.01% may be 0.01% of a large number of impressions or a relatively small number of impressions. The result may be that the data is sparse. Such sparsity of data may lead to a skewed score if considered only by itself. For example, a particular creative may, in reality, have a 1% conversion rate but, due to the sparsity of data, performance data may indicate 5 conversions, 10 clicks, and 20 impressions for that creative. Thus, based on the performance data just for this one creative, the conversion per impression rate may be 25% instead of the actual value 1%. Or, in another example, no performance data may exist for one or more of the creatives. Accordingly, determining the quality of such a creative without any performance data would be inaccurate and biased. Robustness in the creative quality score at the individual creative level may be achieved by exploiting a hierarchical model of the online creatives, as described herein.

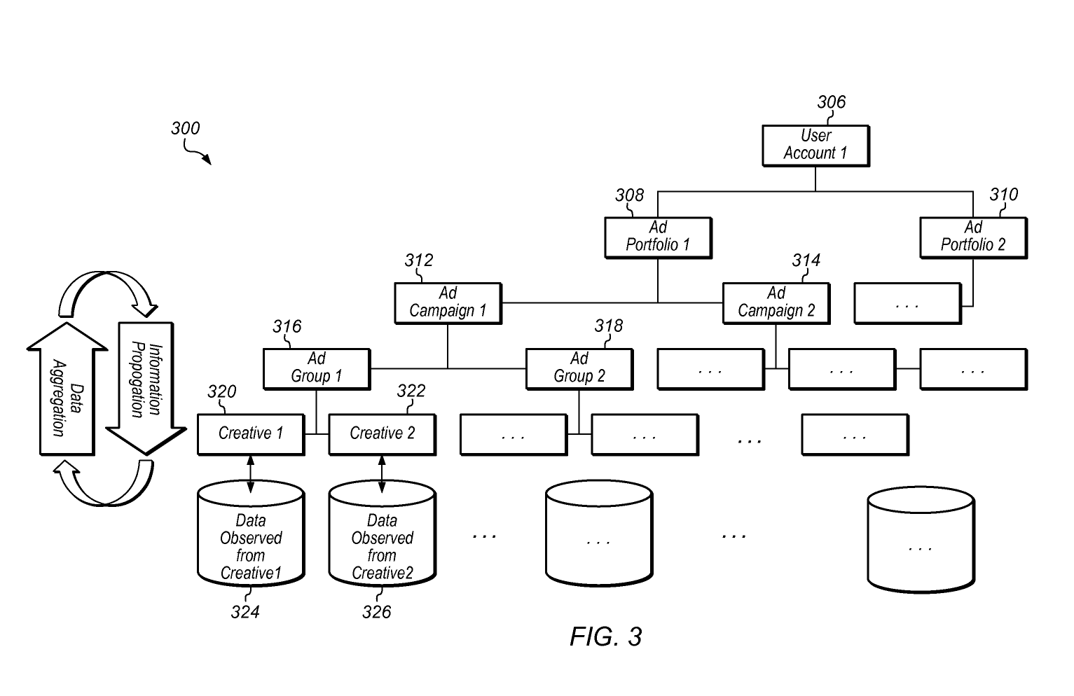

At 220, a hierarchical model of the plurality of online advertisement creatives may be generated, for example, by model generator 152 of scoring module 150, based on respective correlations among the online advertisement creatives. A graphical illustration of an example hierarchical model 300 is shown in FIG. 3. The subunits of the hierarchy may be referred to as nodes with terminal nodes being creatives and non-terminal nodes being ad groups, campaigns, etc. In the example of FIG. 3, the top level of the hierarchy is the user account (e.g., user account 1 306), followed by the advertisement portfolio level (e.g., illustrated with ad portfolio 1 308 and ad portfolio 2 310), advertisement campaign level (e.g., illustrated with ad campaign 1 312, ad campaign 2 314, and an unlabeled ad campaign for ad portfolio 2 310), advertisement group level (illustrated with ad group 1 316, ad group 2 318, and unlabeled ad groups), and creative level (illustrated with creative 1 320, creative 2 322, and unlabeled creatives). Note that other campaigns, groups, and creatives are shown without reference numerals. Moreover, the illustrated hierarchy may include other user accounts, ad portfolios, ad campaigns, ad groups, and creatives that are not shown. For example, in the bottom row, although 5 creatives are shown in the figure, numerous additional creatives may exist for this hierarchy. As shown in FIG. 3 and as described in more detail below, data may be aggregated up the hierarchy and information regarding that data may be propagated down the hierarchy such that data from other nodes may be used to account for the possibility of sparse data for a given creative.

In one embodiment, each creative may belong to at least one of the advertisement groups. As shown in the example of FIG. 3, the quantity of nodes at one level may be greater than the quantity of nodes at a lower level and less than the quantity of nodes at a higher level. For example, the quantity of advertising groups may be less than the quantity of creatives. In other examples, the same number of nodes may exist at multiple different levels of the hierarchy. For instance, consider an example in which two advertisement portfolios, portfolios A and B, each have only one advertising campaign, campaigns A1 and B1. In such an example, the advertising portfolio level has 2 nodes as does the advertising campaign level.

As illustrated at 230, the hierarchical model may be used, for example, by performance estimator 156 of scoring module 150, to estimate a respective performance value for each of at least some of the online advertisement creatives based on the received performance data. In some embodiments, the hierarchical model may also be used to estimate multiple respective performance values for the online advertisement creatives based on the received performance data. Example performance values include click through rate (CTR), revenue per click (RPC), conversion rate, click per impression (CPM), revenue per impression (RPM), revenue, etc. In a simple example, the multiple estimated performance values may be RPC and CTR. In some embodiments, additional other performance values may also be estimated such that more than two estimated performance values are considered.

In one embodiment, each category of performance value may be based on less than all (e.g., a portion) of the performance data. For example, RPC may be based on performance data regarding revenue and clicks, CTR may be based on performance data regarding clicks and impressions, and conversion rate may be based on performance data regarding impressions and conversions. The same hierarchical model may be used at 220 but the different performance values may utilize the hierarchy based on different portions of the received performance data. In addition, computation of the estimations may be performed separately for each different performance value. Thus, a computation may determine the CTR and separate computations may determine RPC and conversion rate.

In some embodiments, estimating performance values may include aggregating the received performance data at one level (e.g., a first level, such as a level above a level that has previously had its performance data aggregated) of the hierarchical model to obtain baseline estimates of the performance values. Additional aggregations at higher levels of the hierarchy may also be performed resulting in additional baseline estimates. Such aggregations may improve the robustness of the data a whole and allow a given creative to use performance data of related nodes (e.g., sibling and/or parent nodes, etc.). The baseline estimates may then be propagated to a lower level than the first level to improve the estimates at a finer level. As a simple example, performance data may be aggregated for the creatives of an ad group, and for that ad group and its sibling ad groups for an ad campaign. A baseline estimate for the child nodes in that ad campaign may be estimated and then propagated back down to the child nodes. Estimating the performance values may further include iterating the aggregating and propagating. For example, the aggregating and propagating may be iterated using an expectation-maximization (EM) algorithm until convergence of the baseline estimates.

As noted above, for some creatives, little or no performance data may be available for those creatives. In estimating the performance values, the hierarchical structure of the model may be exploited such that robust performance values (and robust creative quality scores at 230) may be estimated for even those creatives having little or no performance data. Collectively for the hierarchy, enough data may be available to generate robust performance values and quality scores.

As shown at 240, a creative quality score may be determined, by scoring component 158 of scoring module 150, for the online advertisement creatives. Such a determination may be based on the estimated performance values, which may include the propagated baseline estimates. In embodiments in which multiple performance values are also estimated, the determination of the creative quality scores may be based on the multiple estimated performance values. In one embodiment, the creative quality scores may include a confidence interval around some value. The value may be a mean or some other value and the confidence interval (CI) may be centered around that value. In one embodiment, the mean and confidence interval may be normalized. The mean can be normalized in a number of ways. For example, the mean can be normalized using either the sum of the raw scores or the maximum raw score within an ad group as the denominator. The CI can also be normalized by the same denominator.

In one embodiment, determining the creative quality score for a given creative based on its respective estimated performance values may include aggregating the estimated performance values for that creative. Such an aggregation may be weighted and/or the estimated performance values may be normalized.

In one embodiment, the raw score of creative i may be given by:

Scoreᵢ=CTRᵢ*Obj_value_i per click.

The raw score can be normalized by either the sum of the raw scores or by the maximum raw score within an ad group. Obj_value_i per click may be estimated by adding up the multiple estimates from the hierarchical model, as described herein. The mean score may be estimated as:

E(scoreᵢ)=E(CTRᵢ*Obj_value per click)=E(CTRᵢ)*E(Obj_value per click)

In embodiment in which input indicating a set of parameters was received at block 200, determining the creative quality scores may be further based on the set of parameters. For example, those parameters may define whether to use mean scores, confidence intervals, or both to determine whether to continue a creative. As another example, pausing/continuing a creative may be automatic or manual (e.g., with user input) and may be based on the received set of parameters.

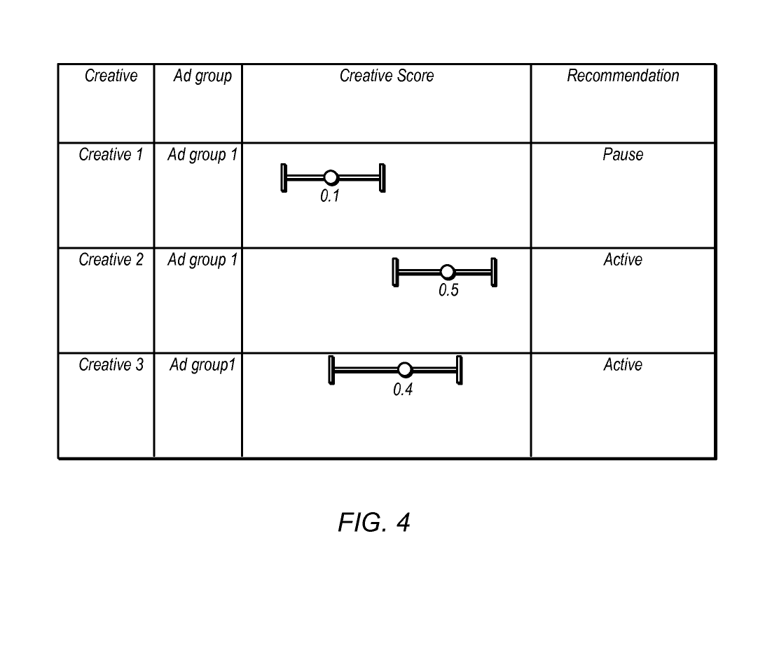

As shown at 250, in some embodiments, the creative quality scores may be provided, by scoring module 150 for example, for display. For instance, the creative quality score may be provided for display via a user interface, such as the example user interface shown in FIG. 4. A user may review a recommendation on continuing/pausing the creatives and/or provide input on whether to continue/pause the creatives. In one embodiment, a user may define a rule such that, based on the performance values, continuing/pausing the creatives may be automatic. Such a rule may include a threshold value or CI relative to which the automatic determination to continue/pause is made.

Based on the creative quality scores, it may be determined, for instance, by scoring module 150, whether to pause and/or continue use of a creative as illustrated at 260. For example, the creative quality score of a first creative in an advertisement group may be compared with the creative quality score of a second creative in the same advertising group. Based on the comparison, it may be determined and/or recommended whether to continue, pause, or otherwise modify one or both of the first and second creatives. For instance, if the respective confidence intervals corresponding to the first and second creatives do not overlap, then the creative having the lower creative quality score and confidence interval may be paused, whereas the one with the higher creative quality score and confidence interval may be continued. In some embodiments, more than two creatives may have their respective quality scores compared. Previously paused creatives may be restored as an active creative based on such a comparison. Comparisons may take place periodically or on demand. For example, a user may provide input, via a user interface, to request a comparison of the creatives and select which creatives to continue and/or pause. As another example, a comparison of the creatives may take place after each scoring of the creatives, which may be periodic (e.g., once an hour, once a day, once a week, etc.). Note that one or more of blocks 200-260 may also be performed periodically such that updated determinations on making a creative active/inactive may be based on updated creative quality scores, which may be determined based on updated performance data.

In one embodiment, determining whether to pause and/or continue a creative may include determining whether the creative quality score for that creative is above, at, or below a threshold value. For example, if the score is below the threshold, then the creative may be paused. Conversely, if the score is at or above the threshold, the creative may be continued. Or, the determination may be based on the confidence interval. For example, it may be determined that the CI's lower or upper bound is above or below a certain value. Continuation of the creative may then be based on such a determination.

One example embodiment for performing the method of FIG. 2 (e.g., block 220, 230, and 240) may include using a recursive Bayesian approach. In the following discussion of an example recursive Bayesian approach, it is assumed that each advertisement group contains more than one creative, and that the same creative can appear in more than one campaign and can likewise appear in more than one advertisement group. Moreover, the following discussion of an example recursive Bayesian approach describes CTR estimation but other performance values may also be estimated in some embodiments. The tree-like hierarchy may be generated based on the creatives' relevance to one another and by keywords associated to the creatives. The hierarchical structure may be referred to as the Ad.Tree. The relationships between the nodes may be given by the context, which may be defined by an assignment of a set of search keywords to the creatives. Note that in many cases, clicks are rare (e.g., less than 5% of impressions) and events generated after the click (e.g., conversion) are even more sparse (e.g., 1/1000 of impressions). The sparsity of data can be even more profound at the introduction of a new creative in the campaign.

In the recursive Bayesian example, the structure of the hierarchical model and correlations between nodes may be used to improve the estimate of a performance value in the form of a posterior estimate. A contemporary estimate of the posterior estimates and of the intermodal correlation may be used to define a prior on the estimate. A score may be computed for each creative such that the higher the score, the more value the creative has if presented.

Let P(Cᵢ) be the probability of creative Cᵢ being clicked, Clicksᵢ=Impressions*P(Cᵢ), and CTRi-Clicks/Impressions=P(Cᵢ). The posterior probability P(Cᵢ|A) of the creative being clicked, knowing the prior A and the likelihood P(Cᵢ), is given by:

$$P ( {C}_{i} \vert A ) = \frac{P ( A \vert {C}_{i} ) P ( {C}_{i} )}{{\sum }_{j}^{ } P ( A \vert {C}_{j} ) P ( {A}_{j} )} .$$

The marginal probability P(Cᵢ) can be estimated from clicks and impressions using an estimator for the binomial distribution. The normalization constant

$${\sum }_{j}^{ } P ( A \vert {C}_{j} ) P ( {A}_{j} )$$

can be computed afterward. The prior probability P(Cᵢ|A) may integrate information regarding the performance of homologous creatives based on the correlation(s) among them. This can be formalized as a recursive Bayesian estimation processed and solved using a Kalman Filter. In turn, the correlation between homologous nodes may depend on the posterior probability in each node, given the CTR estimators in the node. In some embodiments, determining the posterior estimate for the creatives and determining correlations within the Ad.Tree may be achieved using an EM algorithm. The EM algorithm may begin with an initial estimate of the quantities. At each step of the EM algorithm, it may update either the posterior estimates using the correlation at the previous step or it may update the correlation using the posteriors estimated at the previous step, thus converging to a stable (e.g., within an epsilon) solution.

In some embodiments, if the number of clicks for a creative is sufficient, then CTR_{c}=Clicks_{c}/Impressions_{c} may be an accurate estimate of CTR for a creative. CTR_{Ad}=Clicks_{Ad}/Impressions_{Ad} may be an estimate of the CTR of an ad group where clicks and impressions aggregate the events (e.g., performance data) for the whole ad group. Similar baseline estimates may also be estimated for higher level nodes in the hierarchy (e.g., campaign, portfolio, etc.) by repeating such an aggregation of events. The number of impressions at a higher level of the hierarchy may be at least as much as the number of events at a lower level, but generally, it may be much larger at higher levels, thereby increasing the confidence and robustness of the higher level estimates. Thus, the higher in the hierarchy that performance is estimated, the more events are considered and the more robust estimate of the CTR of the aggregate is achieved. In some embodiments, the estimator at a parent level may be used as a prior for the estimator at the descendant level.

In the Bayesian approach, performance data may be preprocessed and/or normalized. Clicks and impressions may be countable events and their distribution may vary in [0,inf] for the impressions and in [0,N_{I}] for the clicks where N_{I} is the number of impressions. In this frameset, the distributions of CTR may be very skewed with variances depending on the mean. The actual value may depend on the equation used to model the hierarchical model generation process. In this setup, the Freeman-Tukey transformation (FTT) has the following properties:

$${y}_{i} = \frac{1}{2} ( \sqrt{\frac{{c}_{i}}{{N}_{i}}} + \sqrt{\frac{{c}_{i} + 1}{{N}_{i}}} )$$

The FFT may also be stable in the presence of rare events and may provide a mean of discrimination between zeros due to under-sampling and zeros due to very rare events. It may stabilize the variance in that the variance may be independent of the mean.

In one embodiment, the performance data may be modeled as a tree structured Markov model. The nodes of the Markov tree may be mapped to nodes of the hierarchical model (e.g., portfolio, campaign, ad group, creative, etc.). Each node may have a respective transformed rate yᵢ, covariate vector uᵢ (prior knowledge that may be added to the item, such as information from leads or it may be fixed to one at first instance), and a latent state of the node, Sᵢ, accounting for creative typical effects not considered by the covariates. The CTRs of the nodes may then be connected to each other by a Markovian relation. The observations may be assumed to be independent and to have Gaussian distribution, conditional on the latent state.

yi|Si,xi˜N(ui□xi+Si;σᵢ²)

where xᵢ is the vector of unknown coefficients of the covariates and σᵢ² is the unknown variance. The state Sᵢ accounts for the effects that are not directly mapped by the covariates in the model. Unconstrained estimation of Sᵢ at the node level may be unstable and can lead to overfitting. To avoid the overfitting, regularization may be applied to Sᵢ.

The behavior of the state may be smooth to exploit the dependencies induced by the tree structure of the data. It may be assumed that the state of a node may be related to the state of its parent.

Sᵢ=Sₚₐ₍ᵢ₎+wᵢ

where Sₚₐ₍ᵢ₎ is the state of the parent node and wᵢ˜N(0,Wᵢ) is Gaussian distributed. It may also be assumed that all nodes at the same level share the same Wᵢ such that Wᵢ:=W^{(l)}.

The variance of the FTT observations σᵢ²(yᵢ)∝1/Nᵢ may allow the assumption that there exists a common Σ^{(l)} such that σᵢ²=Σ^{(l)}/Nᵢ. The amount of regularization that may take place with such an approach may be σᵢ²/Wᵢ. Accordingly, for a small σᵢ, the regularization may likewise be If σᵢ is large, then data is sparse and more data may be borrowed from the other nodes. If Wᵢ is large, then the difference between the brother/neighbor nodes is large.

Considering the independence of Wᵢ and Sₚₐ₍ᵢ₎, the variance of the state, Sᵢ, of a node may depend only on its depth in the hierarchy, l(i). Thus,

$${σ}_{{S}_{i}}^{2} = {\sum }_{l = 1}^{l ( i )} {W}^{( l )}$$

may depend only on the depth of the node and may increase in going from coarse to fine resolution due to fewer samples in the aggregates used for the estimation at finer resolutions. If the node is very low in the hierarchy and close to the leaves, the variance of the state may be high because there are fewer samples in the aggregate. The root node may have the least variance because it can aggregate more data whereas the leaf nodes have the largest variance. Given two nodes n₁ and n₂ at the same level l, sharing a common ancestor n₀ at level l⁰, the covariance between n₁ and n₂ may depend only on the level of the common ancestor l⁰

Cov(Sₙ_{₁},Sₙ_{₂})=σ_{Sn}_{₀}².

In turn, the correlation of nodes at level l sharing a common ancestor at level l⁰ may be

$$Corr ( l , {l}^{0} ) = \frac{{\sum }_{j = 1}^{{l}^{0}} {W}^{( j )}}{{\sum }_{j = 1}^{l} {W}^{( j )}} ,$$

which may depend on the level of the regions and on their distance from the common ancestor. Note that the yᵢ may be independent conditional on their states Sᵢ, but the dependencies in Sᵢ may impose dependencies on the marginal distribution of the observations.

In one embodiment, the estimation process for estimating the CTR may consider the click generating process as a binomial random variable. For computational simplicity, the algorithm may estimate the binomial proportion (e.g., the CTR) by propagating the FFT under the assumption that the node state associated with this quantity is Gaussian distributed. For large numbers of clicks, this assumption may be true thereby allowing a good approximation of both the CTR and confidence interval. When the number of impressions (and in turn clicks) approaches zero, the assumption may not be representative of the data thereby making the CTR strongly driven by the connected nodes with the confidence interval (CI) overestimating the true CI. In some case, the CI might yield values outside the range [0,1] where it should be defined. In the presence of such CIs, the estimated CTR may be used as a preliminary estimate, subject to stabilization as the number of impressions grows.

In one embodiment, portions of the method of FIG. 2 may be implemented using an object oriented design formalized using R5 objects in R. Using R5 objects may allow each object and its attributes to be address-mapped by reference instead of value-mapped, thus allowing for modification of single nodes by detaching the descendants, reevaluating the node, and then reattaching the descendants. Value-mapped nodes, on the other hand, may require a re-instantiation of all the descendants thus generating a considerable memory management overhead. The Ad.Tree may be implemented on a single base class (Node_R5), with the class implementing all instances and methods to build the Ad.Tree hierarchy and perform most of the computations for the EM estimation. This class may be further specialized to define the root of the Ad.Tree (AdTree_R5), the portfolio (AdPortfolio_R5), the campaign (AdCampaign_R5), the ad groups (AdGroup_R5), and the creatives (Creative_R5).

Node_R5 may be characterized by a set of fields used to define the Ad.Tree structure and to qualify each node, by a set of fields to keep track of the input information (e.g., clicks, impressions, etc.), by partial quantities used in prediction, by rules updates, and by the EM technique. The Node_R5 class may also define a set of methods to manage the Ad.Tree Structure and to perform the CTR estimation process together with a set of ancillary functions (e.g., getters and setters, toString, and print functions to visual results, etc.). Each part of the EM process may be managed in two phases: a first phase to compute the mathematics at the current node, and a second phase to commit the descendant nodes to perform the computation in recursive fashion. The phases may depend on the top-down or bottom-up requirements of the algorithm. A bottom-up function may first delegate by recursion of the iteration portion on its descendants, down to the leaves, then call a filterSGamma function on the node itself and returns to allow its ancestor to do the same up to the root node. In contrast, a top-down function may first invoke smoothSGamma_r on the nodes and then commit the descendant nodes to do the same in a top-down fashion from the root to the leaves. The EM algorithm aggregates information and may be performed layer by layer on accumulators in the root node. It then operates on the root and communicates partial quantities for the aggregations.

The AdTree_R5 node may be a specialized sub-class of Node_R5. It may collect information for the definition of the Ad.Tree depth, the information about internode correlation, overall variance, and confidence levels. It may also keep information required by the iterative algorithm to define confidence intervals, stopping criteria, maximum iteration allowed, etc. The AdTree_R5 node may build the tree starting from a data frame containing the dump of the campaign, run the estimation process, check the stopping criteria, and compute the information about total variance, internode, and inter-level correlation.

In one embodiment, a bottomUplter function may compute filtering on all descendants, then on the node itself to allow the invoking node to be served. The filterSGamma r function may perform the actual filtering on the node. If the node is terminal, the predicted state and the state-related variation are set from the state of the previous iteration. If the mode is non-terminal, the filtering may be performed using the current state of the node integrating the estimates of the descendant nodes. The topDownltr function may compute filtering on the node itself and then invoke computation on all descendants. The smoothSGamma_r function may update the predicted state of each node. If the node is root, it may accept the predicted estimate. If the node has an ancestor, it may integrate information pooled from the ancestor in the current node estimate. The expectationMaximizationStep function may compute the discrepancy between the model predicted state and the actual measurement and collect information to perform the EM. The quantities are then processed and finalized in the root node. The estimateBetaAcc function performs the preliminary data collection for the solution of the weighted least square problem and for the estimation of the covariate in the model. The covariate estimation may then be finalized in the root node.

In some embodiments, a logistic regression based hierarchical event rate estimation, also referred to as a binomial approach, may be used. Such an estimation may be similar to the above recursive Bayesian example but may use a Bernoulli likelihood function instead of the Gaussian (normal) likelihood function. Additionally, a logit link function may be used. With such a modification, the normality assumption may not be applied. Instead, it may be assumed that for the same creative, the impressions are independent Bernoulli trials with the same success rate (e.g., CTR or other event rate).

Let Nᵢ denote the number of impressions, yᵢ denote the number of clicks, and pᵢ denote the CTR (or other event rate such as conversion rate, etc.) of creative i. An example logistic regression based model is:

yᵢ|pᵢ˜Binomial(Nᵢ,pᵢ)

logit(pᵢ)=uᵢ·Xᵢ+Sᵢ

Sᵢ=Sₚₐ₍ᵢ₎+wᵢ

Where Sₚₐ₍ᵢ₎ is the state of the parent node and wᵢ˜N(0,Wᵢ) is Gaussian distributed. Further, it may be assumed that all nodes at the same level share the same Wᵢ, thus Wᵢ:=W^{(l)}. In addition, Xᵢ may be the vector of unknown coefficients of the covariates uᵢ. Note that the logit link function may be defined as Logit(pᵢ)=ln(pᵢ/(1−pᵢ)). This model may be nonlinear and non-Gaussian as the probability distribution of the observed parameter is Binomial and the link function is non-linear.

For computational simplicity, the binomial approach may be modeled as an iterative extended Kalman filter solution of a linear Gaussian System approximating the binomial model. The binomial distribution may be a special case in the exponential family.

yᵢ|pᵢ˜exp(yᵢpᵢ−b(pᵢ))+c(yᵢ))≡Binomial(Nᵢ,pᵢ),

where

b(pᵢ)=n log(1+exp(pᵢ))

$$c ( {y}_{i} ) = log ( \begin{matrix}{N}_{i} \\ {y}_{i}\end{matrix} )$$

### Let

λᵢ=logit(pᵢ)=uᵢ·Xᵢ+Sᵢ

pᵢ=expit(λᵢ)

Sᵢ=Sₚₐ₍ᵢ₎+wᵢ

wᵢ˜Normal(0,Σᵢ)

To estimate the posterior mode of the latent process, a local linearization of the response function is introduced. The observation model may be locally approximated with a Gaussian observation model. The distribution of the underlying process may be Gaussian by hypothesis. The Kalman filter may then be applied to smooth the approximated Gaussian state space model. Such a technique may be referred to as the extended Kalman filter and smoother. The approximation can then be improved by iteration leading to the iterated extended Kalman filter and smoother. The iteration is implemented after the update of the meta parameters common to the aggregate information at different levels of the AdTree. At each iteration, the following equation may be determined:

$$\begin{matrix}{\tilde{y}}_{i} = {b}^{′} ( {λ}_{i} ) [ {y}_{i} - b ( {λ}_{i} ) ] + {λ}_{i} \\ = \frac{{y}_{i}}{{N}_{i}} exp ( - {λ}_{i} ) {( 1 + exp ( {λ}_{i} ) )}^{2} - exp ( {λ}_{i} ) - 1 + {λ}_{i}\end{matrix}$$

where λᵢ is the estimate parameter at the previous iteration. In the absence of inter-nodal correlation, the approximating variance may be given by:

$$\begin{matrix}{V}_{i} = {[ {b}^{′} ( {λ}_{i} ) {\sum }^{- 1} {b}^{′} ( {λ}_{i} ) ]}^{- 1} \\ = \frac{exp ( - {λ}_{i} ) {( 1 + exp ( {λ}_{i} ) )}^{2}}{{N}_{i}} .\end{matrix}$$

It may be assumed that the inter-nodal correlation is the same as in the Gaussian case. The nodal variance may be estimated by taking into account the total contribution of each node and the correlation imposed by the AdTree structure. The variance may be estimated as described above, which may implicitly approximate the Binomial with the best approximating Normal estimated using meta-observations \tilde{y}ᵢ and matching variance. The covariate parameter β may be estimated using a weighted linear regression on the covariate with yᵢ replaced by \tilde{y}ᵢ.

As mentioned above, although certain examples describe CTR estimation, the method can be applied to determine other performance values such as RPC, RPM, and/or other metrics. Scenarios in which the dependent variable can be converted to the counts of independent events, a binomial distribution is appropriate. For example, a revenue metric may be a weighted sum of multiple properties, such as application installation, registration, “liked”, etc. Each of the properties can be regarded as an event and the model can be used to estimate the rate of each event separately. Then, the revenue metric can be derived by a weighted sum of the separated estimations.

FIG. 4 illustrates an example user interface useable to display creative quality scores and/or continue or pause a creative. From left to right, the columns of the illustrated user interface display the creative, ad group, creative score, and recommendation, respectively. The row for creative 1 shows that creative 1 belongs to ad group 1 and has a creative score of 0.1 with a confidence interval around 0.1. Creatives 2 and 3 each also belong to ad group 1 and have creative scores of 0.5 and 0.4, respectively. As shown, a recommendation for creative 1 is to pause the creative whereas the recommendation for creatives 2 and 3 is to keep/make the creatives active. A variety of criteria may be used to determine whether to pause or continue a creative, as described herein. For example, here, the upper bound of Creative 1's confidence interval falls below the lower bound of Creative 2's confidence interval. Such a non-overlapping confidence interval may result in a recommendation of pausing the lower scored creative. Or, the actual score (e.g., mean) of 0.1 for Creative 1 may fall below a threshold value, such as 0.3, for maintaining the creative in an active state. Moreover, the pause/continue recommendation may automatically be applied, or may be manually selected through the interface. Toggling between automatic and manual mode may also be performed through the interface of FIG. 4.

### Exemplary Computer System

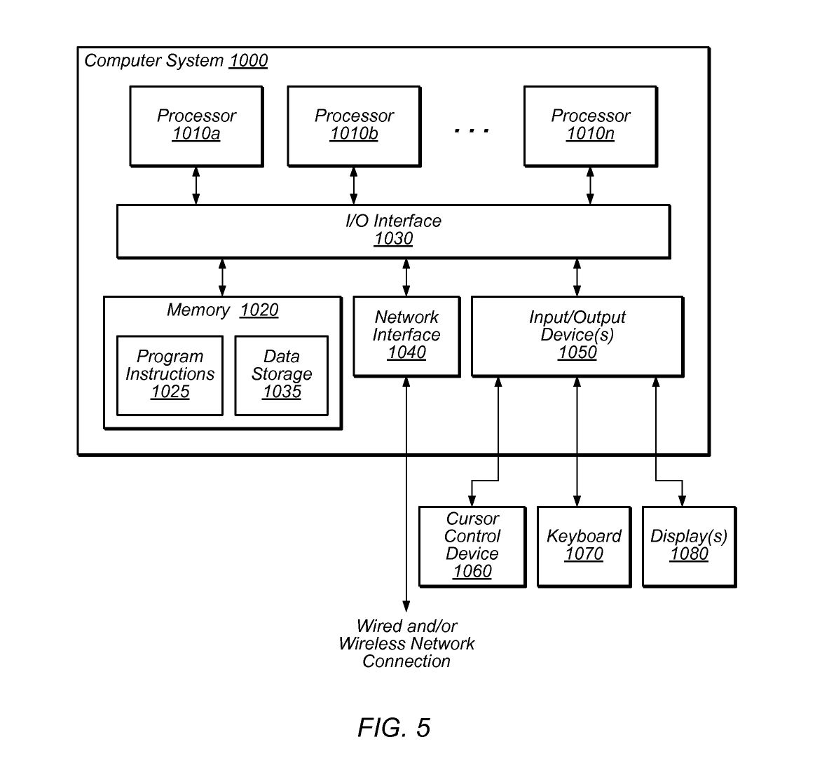

Various portions of a scoring module may be executed on one or more computer systems, which may interact with various other devices. One such computer system is illustrated by FIG. 5. For example, client 110, browser application 112, publisher 120, ad server 130, analytics provider 140, scoring module 150, and advertiser 160 may each include, employ or be executed on one or more computer systems.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, audio device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit (GPU) may be considered a dedicated graphics-rendering device for a personal computer, workstation, game console or other computer system. GPUs may be very efficient at manipulating and displaying computer graphics and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for hierarchical-model-based creative quality scoring may be implemented by program instructions configured for execution on one of, or parallel execution on two or more of, such GPUs. The GPU(s) may implement one or more application programming interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a hierarchical-model-based creative quality scoring method, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network (e.g., network 108), such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

Memory 1020 may include program instructions 1025, configured to implement embodiments of a scoring module as described herein, and data storage 1035, comprising various data accessible by program instructions 1025. In one embodiment, program instructions 1025 may include software elements of a hierarchical-model-based creative quality scoring method illustrated in the above Figures. Data storage 1035 may include data that may be used in embodiments. In other embodiments, other or different software elements and/or data may be included.

Those skilled in the art will appreciate that computer system 1000 is merely illustrative and is not intended to limit the scope of hierarchical-model-based creative quality scoring as described herein. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the disclosed embodiments may be practiced with other computer system configurations. In some embodiments, portions of the techniques described herein may be hosted in a cloud computing infrastructure.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the embodiments embrace all such modifications and changes and, accordingly, the above description to be regarded in an illustrative rather than a restrictive sense.

What is claimed is:

1. A method, comprising:
performing by one or more computing devices:
receiving performance data for a plurality of online advertisement creatives;
generating a hierarchical model of the plurality of online advertisement creatives based on respective correlations among the plurality of online advertisement creatives;
using the hierarchical model to estimate a respective performance value for each of at least some of the plurality of online advertisement creatives based on the received performance data; and
determining a creative quality score for each of the at least some of the plurality of online advertisement creatives based on the estimated performance values.

2. The method of claim 1, further comprising:
using the hierarchical model to estimate another respective performance value for each of the at least some of the plurality of online advertisement creatives based on the received performance data;
wherein said determining the creative quality score for each of the at least some of the plurality of online advertisement creatives is further based on the other estimated performance values.

3. The method of claim 1, wherein the hierarchical model includes multiple levels including:
a first level that includes the plurality of online advertisement creatives, and
a second level that includes a plurality of advertising groups, wherein each creative belongs to at least one of the plurality of advertising groups, wherein a quantity of the advertising groups is less than a quantity of the creatives.

4. The method of claim 1, wherein each creative quality score includes a confidence interval.

5. The method of claim 1, further comprising:
determining whether to continue a first creative of the plurality of creatives based on its respective creative quality score.

6. The method of claim 5, wherein said determining whether to continue the first creative includes determining to pause use of the first creative in response to a determination that an upper bound of a confidence interval of the creative quality score of the first creative is less than a lower bound of a confidence interval of the creative quality score of a second creative of plurality of creatives, wherein the first and second creatives are from a same advertising group.

7. The method of claim 1, wherein the received performance data for the plurality of online advertisement creatives is sparse for at least one of the plurality of online advertisement creatives.

8. The method of claim 1, wherein said estimating performance values includes:
aggregating the received performance data at a first level of the hierarchical model to obtain baseline estimates of the performance values, and
propagating the baseline estimates to a level lower than the first level, wherein said determining the creative quality score is further based on the propagated baseline estimates.

9. The method of claim 8, wherein said estimating performance values further includes iterating said aggregating and propagating using an expectation-maximization (EM) technique until convergence of the baseline estimates.

10. The method of claim 1, further comprising:
receiving input indicating a set of parameters, wherein said determining the creative quality score for each creative is further based on the set of parameters.

11. The method of claim 1, further comprising providing at least one of the determined creative quality scores for display.

12. A non-transitory computer-readable storage medium storing program instructions, wherein the program instructions are computer-executable to implement:
receiving performance data for a plurality of online advertisement creatives;
generating a hierarchical model of the plurality of online advertisement creatives based on respective correlations among the plurality of online advertisement creatives;
using the hierarchical model to estimate a respective performance value for each of at least some of the plurality of online advertisement creatives based on the received performance data; and
determining a creative quality score for each of the at least some of the plurality of online advertisement creatives based on the estimated performance values.

13. The non-transitory computer-readable storage medium of claim 12, wherein the program instructions are further computer-executable to implement:
using the hierarchical model to estimate another respective performance value for each of the at least some of the plurality of online advertisement creatives based on the received performance data;
wherein said determining the creative quality score for each of the at least some of the plurality of online advertisement creatives is further based on the other estimated performance values.

14. The non-transitory computer-readable storage medium of claim 12, wherein the hierarchical model includes multiple levels including:
a first level that includes the plurality of online advertisement creatives, and
a second level that includes a plurality of advertising groups, wherein each creative belongs to at least one of the plurality of advertising groups, wherein a quantity of the advertising groups is less than a quantity of the creatives.

15. The non-transitory computer-readable storage medium of claim 12, wherein the program instructions are further computer-executable to implement:
determining whether to continue a first creative of the plurality of creatives based on its respective creative quality score.

16. The non-transitory computer-readable storage medium of claim 12, wherein said estimating performance values includes:
aggregating the received performance data at a first level of the hierarchical model to obtain baseline estimates of the performance values, and
propagating the baseline estimates to a level lower than the first level, wherein said determining the creative quality score is further based on the propagated baseline estimates.

17. A system, comprising:
a receiving component implemented on a computing device having at least one processor, wherein the receiving component is configured to:
receive the performance data for the plurality of online advertisement creatives from the data store;
a model generator coupled to the receiving component, wherein the model generator is implemented on the computing device having at least the one processor, wherein the model generator is configured to:
generate a hierarchical model of the plurality of online advertisement creatives based on respective correlations among the plurality of online advertisement creatives;
a performance estimator coupled to the model generator, wherein the performance estimator is implemented on the computing device having at least the one processor, wherein the performance estimator is configured to:
use the hierarchical model to estimate a respective performance value for each of at least some of the plurality of online advertisement creatives based on the received performance data; and
a scoring component coupled to the model generator, wherein the scoring component is implemented on the computing device having at least the one processor, wherein the scoring component is configured to:
determine a creative quality score for each of the at least some of the plurality of online advertisement creatives based on the estimated performance values.

18. The system of claim 17, wherein the performance estimator is further configured to:
use the hierarchical model to estimate another respective performance value for each of the at least some of the plurality of online advertisement creatives based on the received performance data;
wherein said determining the creative quality score for each of the at least some of the plurality of online advertisement creatives, by the scoring component, is further based on the other estimated performance values.

19. The system of claim 17, wherein the scoring component is further configured to:
determine whether to continue a first creative of the plurality of creatives based on its respective creative quality score.

20. The system of claim 17, wherein said estimating performance values includes:
aggregating the received performance data at a first level of the hierarchical model to obtain baseline estimates of the performance values, and
propagating the baseline estimates to a level lower than the first level, wherein said determining the creative quality score is further based on the propagated baseline estimates.
